(19) United States
(12) Patent Application Publication
(10) Pub. No.: US 2023/0019793 A1
(43) Pub. Date: Jan. 19, 2023

(54) Food Gripping Assembly

(71) Applicant: Brad Speidell, Denver, CO (US)

(72) Inventor: Brad Speidell, Denver, CO (US)

(21) Appl. No.: 17/374,491

(22) Filed: Jul. 13, 2021

(51) Int. Cl. A47J 43/28; A41D 19/015

(52) U.S. Cl. CPC A47J 43/283; A41D 19/01547

(57) ABSTRACT

A food gripping assembly includes a panel that has a first side, a second side, a first end edge, a second end edge, a first lateral edge and a second lateral edge. The panel has a fold line therein extending from the first lateral edge to the second lateral edge allowing the second side to be folded onto itself such that the first and second end edges are positioned adjacent to each other. A pair of finger pockets is attached to the front side and the fold line is positioned between the finger pockets. Each of the finger pockets has a receiving opening is directed toward the fold line. The first and second end edges are spaced from each other to extend the panel around a food article and then closed onto the food article.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to food handling devices and more particularly pertains to a new food handling device for facilitating the gripping of finger snack foods while preventing food residue from those foods from staining or coating a person's fingers.

### (2) Description of Related Art Including Information Disclosed Under 37 CFR 1.97 and 1.98

The prior art relates to food handling devices used for gripping a food item such that it can be placed in a person's mouth.

### BRIEF SUMMARY OF THE INVENTION

An embodiment of the disclosure meets the needs presented above by generally comprising a panel that has a first side, a second side, a first end edge, a second end edge, a first lateral edge and a second lateral edge. The panel has a fold line therein extending from the first lateral edge to the second lateral edge allowing the second side to be folded onto itself such that the first and second end edges are positioned adjacent to each other. A pair of finger pockets is attached to the front side such that the fold line is positioned between the finger pockets. Each of the finger pockets has a receiving opening is directed toward the fold line. The first and second end edges are spaced from each other to extend around a food article and then closed onto the food article such that fingers positioned in the finger pockets will be protected from residue from the food article.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric side in-use view of a food gripping assembly according to an embodiment of the disclosure.

FIG. 2 is a front isometric view of an embodiment of the disclosure.

FIG. 3 is a rear view of an embodiment of the disclosure.

FIG. 4 is a side view of an embodiment of the disclosure.

FIG. 5 is a front isometric view of an embodiment of the disclosure.

### DETAILED DESCRIPTION OF THE INVENTION

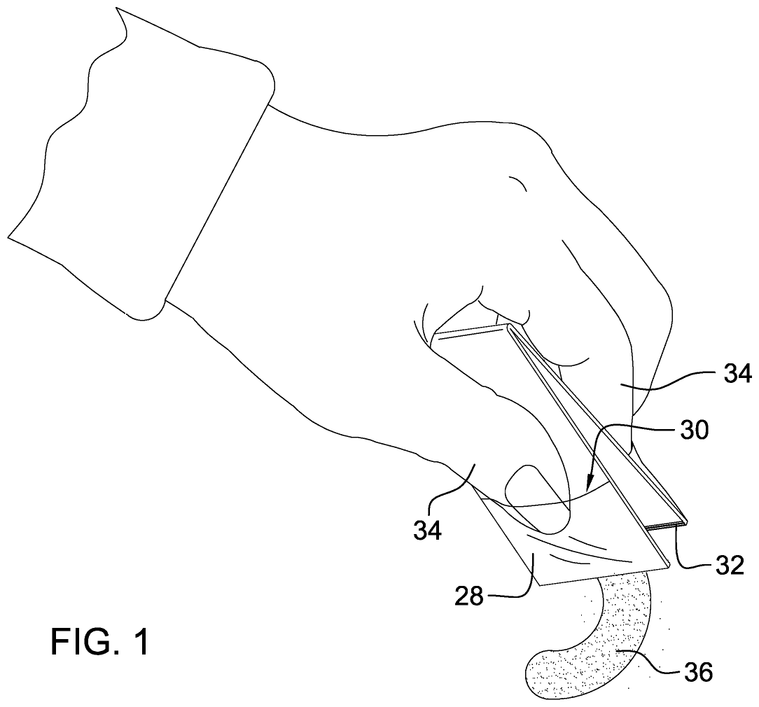

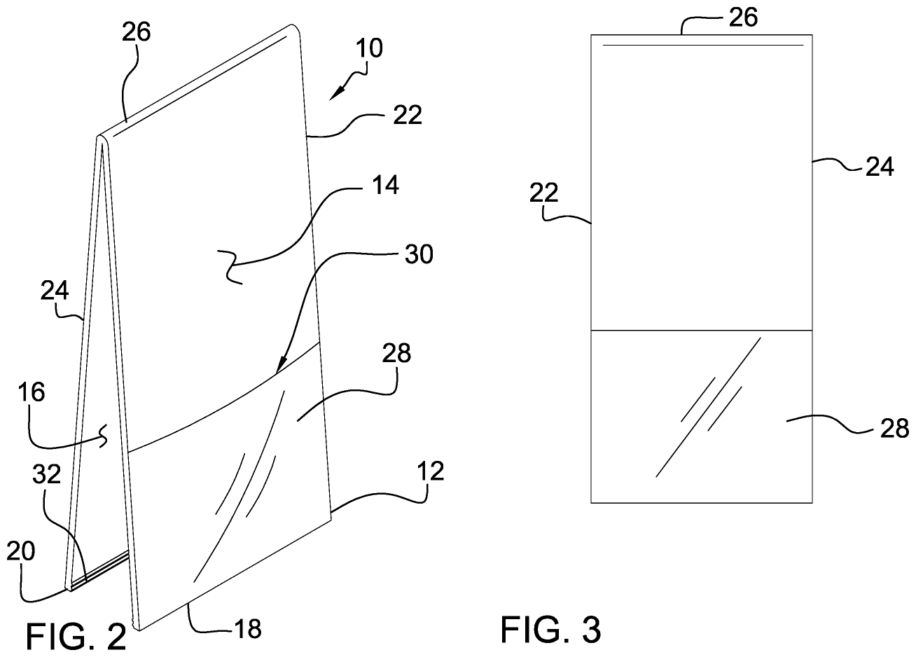

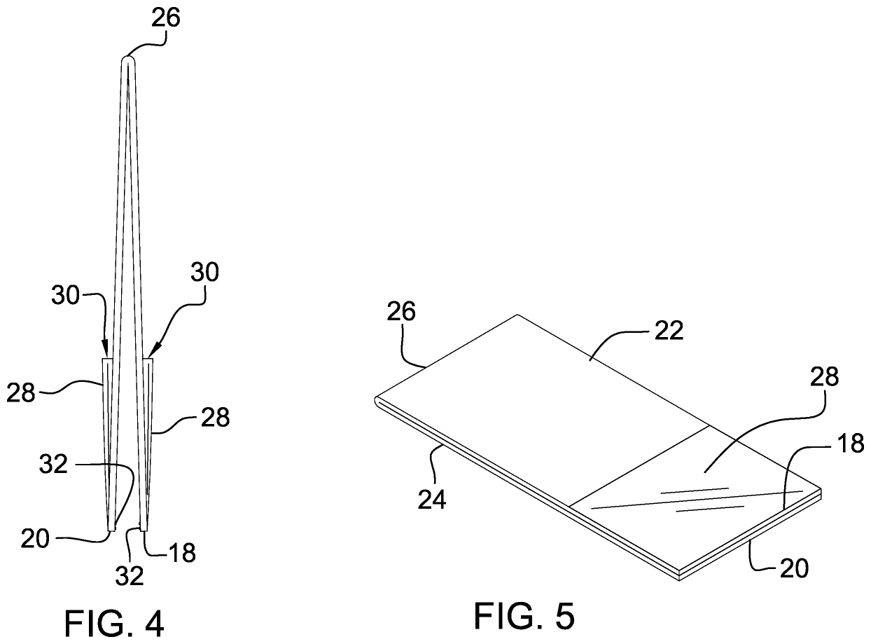

With reference now to the drawings, and in particular to FIGS. 1 through 5 thereof, a new food handling device embodying the principles and concepts of an embodiment of the disclosure and generally designated by the reference numeral 10 will be described.

As best illustrated in FIGS. 1 through 5, the food gripping assembly 10 generally comprises a panel 12 with a first side 14, a second side 16, a first end edge 18, a second end edge 20, a first lateral edge 22 and a second lateral edge 24. The panel 12 has a fold line 26 therein extending from the first lateral edge 22 to the second lateral edge 24. The fold line 26 will typically be orientated perpendicular to the first 22 and second 24 lateral edges. The fold line 26 allows the second side 16 to be folded onto itself such that the first 18 and second 20 edges are positioned adjacent to each other. The fold line 26 may be positioned such that it is equally distant from the first 22 and second 24 lateral edges.

The panel 12 is comprised of a resiliently flexible material which may include plastics, paper products, and the like. Paper products may include any conventional pulp material used to make paper or cardboard like materials. Preferably, the resiliently flexible material will be one which is made from biodegradable materials.

The panel 12 will typically have a length from the first end edge 18 to the second end edge 20 is between 2.0 inches and 6.0 inches and the panel a width from the first lateral edge 22 to the second lateral edge 24 is between 0.75 inches and 2.0 inches.

A pair of finger pockets 28 is attached to the front side such that the fold line is positioned between the finger pockets 28. Each of the finger pockets 28 has a receiving opening 30 that directed toward the fold line 26. One of the finger pockets 28 is positioned adjacent to the first end edge end 18 and one of the finger pockets 28 is positioned adjacent to the second end edge 20. Each of the finger pockets 28 has a depth that is less than 2.0 inches. The finger pockets 28 are each comprised of a flexible material such as plastics, paper materials and the like. It should be noted that a re-usable and washable embodiment of the assembly 10 may include a panel 12 comprised of a plastic or rubber material and finger pockets 28 comprising the same.

One or more gripping ridges 32 may be positioned on the second side 16. Each of the first 18 and second 20 end edges have one of the gripping edges 32 thereon. The gripping edges may have a pointed apex and are used to enhance the friction engaging properties of the assembly 10. The gripping ridges 32 extend from the first lateral edge 22 to the second lateral edge 24.

In use, a person places fingers 34 in the finger pockets such that each finger pocket 28 contains one finger 34. Most often, though not essentially, one finger pocket 28 may receive an index finger while the other finger pocket 28 receives a thumb. The first 18 and second 20 end edges may be spaced from each other by the spreading of the person's fingers 34 to form a gripping space that receives and extends around a food article 36. The first 18 and second 20 end edges are then closed onto the food article 36 to frictionally engage the food article 36. However, since the panel 12 is between the person's fingers 34 and the food article 36, the fingers 34 will be protected from residue from the food article 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A gripping device configured for gripping an article of food to protect a person's fingers from food residue, the gripping device comprising:
a panel having a first side, a second side, a first end edge, a second end edge, a first lateral edge and a second lateral edge, the panel having a fold line therein extending from the first lateral edge to the second lateral edge, the fold line allowing the second side to be folded onto itself such that the first and second end edges are positioned adjacent to each other;
a pair of finger pockets being attached to the front side such that the fold line is positioned between the finger pockets, each of the finger pockets having a receiving opening being directed toward the fold line; and
wherein the first and second end edges are spaced from each other to extend around a food article and then closed onto the food article such that fingers positioned in the finger pockets will be protected from residue from the food article.

2. The gripping device according to claim 1, wherein the fold line is orientated perpendicular to the first and second lateral edges.

3. The gripping device according to claim 2, wherein the fold line is equally distant from the first and second lateral edges.

4. The gripping device according to claim 1, wherein the panel is comprised of a resiliently flexible material.

5. The gripping device according to claim 1, wherein the panel has a length from the first end edge to the second end edge being between 2.0 inches and 6.0 inches, the panel having a width from the first lateral edge to the second lateral edge being between 0.75 inches and 2.0 inches.

6. The gripping device according to claim 3, wherein the panel has a length from the first end edge to the second end edge being between 2.0 inches and 6.0 inches, the panel having a width from the first lateral edge to the second lateral edge being between 0.75 inches and 2.0 inches.

7. The gripping device according to claim 1, wherein one of the finger pockets being positioned adjacent to the first end edge and one of the finger pockets being positioned adjacent to the second end edge.

8. The gripping device according to claim 7, wherein each of the finger pockets has a depth being less than 2.0 inches.

9. The gripping device according to claim 1, wherein each of the finger pockets is comprised of a flexible material.

10. The gripping device according to claim 8, wherein the panel has a length from the first end edge to the second end edge being between 2.0 inches and 6.0 inches, the panel having a width from the first lateral edge to the second lateral edge being between 0.75 inches and 2.0 inches.

11. The gripping device according to claim 10, further including a pair of gripping ridges positioned on the second side, one of said gripping ridges being positioned adjacent to said first end edge and one of said gripping ridges being positioned adjacent to said second end edge, each of said gripping ridges extending from said first lateral edge to said second lateral edge, said gripping ridges enhancing friction between the panel and an article of food.

12. The gripping device according to claim 1, further including a pair of gripping ridges positioned on the second side, one of said gripping ridges being positioned adjacent to said first end edge and one of said gripping ridges being positioned adjacent to said second end edge, each of said gripping ridges extending from said first lateral edge to said second lateral edge, said gripping ridges enhancing friction between the panel and an article of food.

13. A gripping device configured for gripping an article of food to protect a person's fingers from food residue, the gripping device comprising:
a panel having a first side, a second side, a first end edge, a second end edge, a first lateral edge and a second lateral edge, the panel having a fold line therein extending from the first lateral edge to the second lateral edge, the fold line being orientated perpendicular to the first and second lateral edges, the fold line allowing the second side to be folded onto itself such that the first and second end edges are positioned adjacent to each other, the fold line being equally distant from the first and second lateral edges, the panel being comprised of a resiliently flexible material;
the panel having a length from the first end edge to the second end edge being between 2.0 inches and 6.0 inches, the panel having a width from the first lateral edge to the second lateral edge being between 0.75 inches and 2.0 inches;
a pair of finger pockets being attached to the front side such that the fold line is positioned between the finger pockets, each of the finger pockets having a receiving opening being directed toward the fold line, one of the finger pockets being positioned adjacent to the first end edge and one of the finger pockets being positioned adjacent to the second end edge, each of the finger pockets having a depth being less than 2.0 inches, the finger pockets each being comprised of a flexible material; and
wherein the first and second end edges are spaced from each other to extend around a food article and then closed onto the food article such that fingers positioned in the finger pockets will be protected from residue from the food article.

14. The gripping device according to claim 13, further including a pair of gripping ridges positioned on the second side, one of said gripping ridges being positioned adjacent to said first end edge and one of said gripping ridges being positioned adjacent to said second end edge, each of said gripping ridges extending from said first lateral edge to said second lateral edge, said gripping ridges enhancing friction between the panel and an article of food.
